(19) United States
(12) Patent Application Publication
(10) Pub. No.: US 2025/0330804 A1
(43) Pub. Date: Oct. 23, 2025

(54) COMMUNICATION METHODS, TERMINAL DEVICES AND NETWORK DEVICES

(71) Applicant: GUANGDONG OPPO MOBILE TELECOMMUNICATIONS CORP., LTD., Dongguan (CN)

(72) Inventor: Dexin LI, Dongguan (CN)

(21) Appl. No.: 19/254,615

(22) Filed: Jun. 30, 2025

Related U.S. Application Data
(63) Continuation of application No. PCT/CN2022/144020, filed on Dec. 30, 2022.

(51) Int. Cl. H04W 8/24

(52) U.S. Cl. CPC H04W 8/24

(57) ABSTRACT

A method for communication includes: transmitting, by a terminal device, first capability information; where the first capability information is associated with a first model, and the first capability information is used for indicating one piece of the following information: information of a resource capable of being used by the first model, and information of a running process of the first model.

### CROSS-REFERENCE TO RELATED APPLICATIONS

This application is a continuation of International Application No. PCT/CN2022/144020 filed on Dec. 30, 2022, which is incorporated herein by reference in its entirety.

### TECHNICAL FIELD

The present disclosure relates to the field of communication technology, and in particular, to a method for communication, a terminal device and a network device.

### BACKGROUND

Capability information of a terminal device reported is based on a fixed reference indicator. Specifically, the capability information is generally reported at one time, and specific information reported thereby is an inherent attribute at the terminal device level. The inherent attribute may include, for example, an artificial intelligence (AI) capability level supported by a chip of the terminal device. However, during an actual running process of the terminal device, task models at different levels can work together in parallel. In other words, resources capable of being allocated to models at different times and under different tasks change dynamically. The dynamically changing resources will directly affect whether the model can run normally and the effect of running. That is, a model determined based on the capability information of an inherent attribute category is difficult to keep working normally.

### SUMMARY

The present disclosure provides a method for communication, a terminal device and a network device. Each aspect involved in the present disclosure will be described below.

In a first aspect, a method for communication is provided, which includes: transmitting, by a terminal device, first capability information; where the first capability information is associated with a first model, and the first capability information is used for indicating one piece of the following information: information of a resource capable of being used by the first model, and information of a running process of the first model.

In a second aspect, a method for communication is provided, which includes: receiving, by a network device, first capability information transmitted by a terminal device; where the first capability information is associated with a first model, and the first capability information is used for indicating one piece of the following information: information of a resource capable of being used by the first model, and information of a running process of the first model.

In a third aspect, a terminal device is provided, which includes: a first transmitting unit, configured to transmit first capability information; where the first capability information is associated with a first model, and the first capability information is used for indicating one piece of the following information: information of a resource capable of being used by the first model, and information of a running process of the first model.

In a fourth aspect, a network device is provided, which includes: a second receiving unit, configured to receive first capability information transmitted by a terminal device; where the first capability information is associated with a first model, and the first capability information is used for indicating one piece of the following information: information of a resource capable of being used by the first model, and information of a running process of the first model.

In a fifth aspect, a terminal device is provided, which includes a processor and a memory, where the memory is configured to store one or more computer programs, and the processor is configured to call the computer program(s) in the memory, to enable the terminal device to perform some or all of the steps of the method in the first aspect.

In a sixth aspect, a network device is provided, which includes a processor, a memory and a transceiver, where the memory is configured to store one or more computer programs, and the processor is configured to call the computer program(s) in the memory, to enable the network device to perform some or all of the steps of the method in the second aspect.

In a seventh aspect, embodiments of the present disclosure provide a communication system, and the system includes the terminal device and/or network device as described above. In another possible design, the system may further include another device interacting with the terminal device or network device in the solution provided in the embodiments of the present disclosure.

In an eighth aspect, the embodiments of the present disclosure provide a non-transitory computer-readable storage medium, and the non-transitory computer-readable storage medium has stored a computer program, where the computer program enables a terminal device and/or a network device to perform some or all of the steps of the method in each of the above aspects.

In a ninth aspect, the embodiments of the present disclosure provide a computer program product, where the computer program product includes a non-transitory computer-readable storage medium having stored a computer program, and the computer program is executable to enable a terminal device and/or a network device to perform some or all of the steps of the method in each of the above aspects. In some implementations, the computer program product may be a software installation package.

In a tenth aspect, the embodiments of the present disclosure provide a chip, and the chip includes a memory and a processor, where the processor may call a computer program from the memory and run the computer program, to implement some or all of the steps described in the method in each of the above aspects.

### BRIEF DESCRIPTION OF THE DRAWINGS

FIG. 1 is a schematic diagram of a wireless communication system to which embodiments of the present disclosure are applicable.

FIG. 2 is an example diagram of a neural network model.

FIG. 3 is an example diagram of a channel state information feedback system.

FIG. 4A and FIG. 4B are each an example diagram of a beam scanning process.

FIG. 5 is a workflow example diagram of an online learning solution.

FIG. 6 is a schematic flowchart of a method for communication provided in the embodiments of the present disclosure.

FIG. 7 is a schematic flowchart of another method for communication provided in the embodiments of the present disclosure.

FIG. 8 is a schematic flowchart of another method for communication provided in the embodiments of the present disclosure.

FIG. 9 is a schematic flowchart of another method for communication provided in the embodiments of the present disclosure.

FIG. 10 is a schematic flowchart of another method for communication provided in the embodiments of the present disclosure.

FIG. 11 is a schematic structural diagram of a terminal device provided in the embodiments of the present disclosure.

FIG. 12 is a schematic structural diagram of a network device provided in the embodiments of the present disclosure.

FIG. 13 is a schematic structural diagram of an apparatus for communication provided in the embodiments of the present disclosure.

### DETAILED DESCRIPTION

The technical solution of the present disclosure will be described below in conjunction with the accompanying drawings.

### Communication System

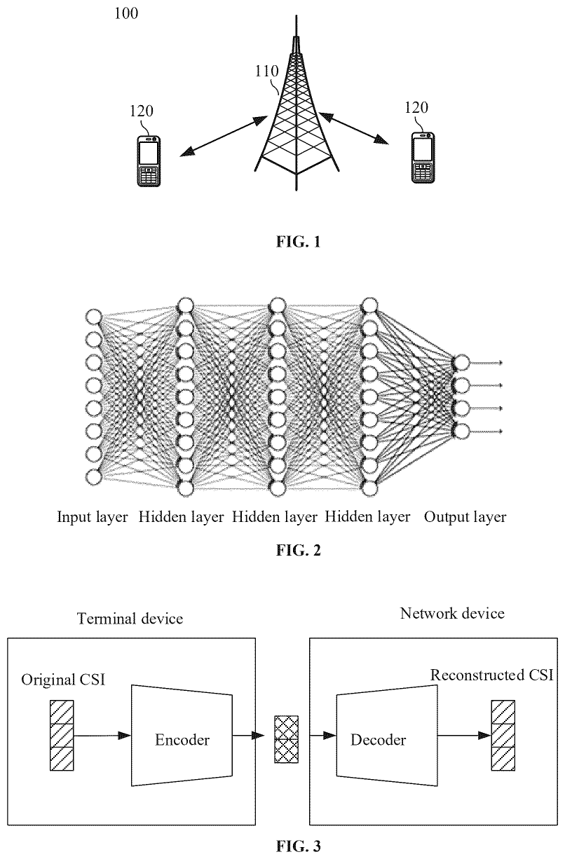

FIG. 1 illustrates a wireless communication system 100 to which the embodiments of the present disclosure are applicable. The wireless communication system 100 may include a network device 110 and terminal devices 120. The network device 110 may be a device that may communicate with the terminal devices 120. The network device 110 may provide communication coverage for a specific geographical area and may communicate with the terminal devices 120 located within the coverage area.

FIG. 1 exemplarily illustrates one network device and two terminal devices. Optionally, the wireless communication system 100 may include a plurality of network devices, and there may be another number of terminal devices within the coverage area of each network device, which is not limited in the embodiments of the present disclosure.

Optionally, the wireless communication system 100 may further include other network entities such as a network controller and a mobility management entity, which are not limited in the embodiments of the present disclosure.

It should be understood that the technical solutions of the embodiments of the present disclosure may be applied to various communication systems, such as a 5th generation (5G) system or new radio (NR), a long-term evolution (LTE) system, an LTE frequency division duplex (FDD) system, and LTE time division duplex (TDD). The technical solutions provided in the present disclosure may further be applied to future communication systems, such as a 6th generation mobile communication system, or a satellite communication system.

The terminal device in the embodiments of the present disclosure may also be referred to as a user equipment (UE), an access terminal, a user unit, a user station, a mobile site, a mobile station (MS), a mobile terminal (MT), a remote station, a remote terminal, a mobile device, a user terminal, a terminal, a wireless communication device, a user agent, or a user device. The terminal device in the embodiments of the present disclosure may refer to a device that provides voice and/or data connectivity to a user, which may be used to connect people, objects, and machines, such as a handheld device or an in-vehicle device with wireless connection functions. The terminal device in the embodiments of the present disclosure may be a mobile phone, a pad, a laptop computer, a handheld computer, a mobile internet device (MID), a wearable device, a virtual reality (VR) device, an augmented reality (AR) device, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in a smart home, or the like. Optionally, the UE may act as a base station. For example, the UE may act as a scheduling entity that provides sidelink signals between UEs in vehicle-to-everything (V2X) or device to device (D2D). For example, a cellular phone and a car communicate with each other using sidelink signals. The cellular phone and a smart home device communicate with each other without relaying communication signals through the base station.

The network device in the embodiments of the present disclosure may be a device for communicating with the terminal device, and the network device may also be referred to as an access network device or a wireless access network device. For example, the network device may be a base station. The network device in the embodiments of the present disclosure may refer to a radio access network (RAN) node (or device) that accesses the terminal device to a wireless network. The base station may be generalized to cover the following various names, or be substituted with the following names, such as: NodeB, evolved base station (evolved NodeB, cNB), next generation base station (next generation NodeB, gNB), relay station, access point, transmitting and receiving point (TRP), transmitting point (TP), master station (MeNB), secondary station (SeNB), multi-standard radio (MSR) node, home base station, network controller, access node, wireless node, access point (AP), transmission node, transceiver node, base band unit (BBU), remote radio unit (RRU), active antenna unit (AAU), remote radio head (RRH), central unit (CU), distributed unit (DU), and positioning node. The base station may be a macro base station, a micro base station, a relay node, a donor node, or an analogue or combination thereof. The base station may also refer to a communication module, a modem or a chip for being provided within the above device or apparatus. The base station may also be a device that performs base station functions in a mobile switching center, D2D, V2X, and machine-to-machine (M2M) communications, a network side device in a 6G network, a device that performs base station functions in future communication systems, or the like. The base stations may support networks with the same or different access technologies. The specific technology and specific device form adopted by the network device are not limited in the embodiments of the present disclosure.

The base station may be fixed or mobile. For example, a helicopter or drone may be configured to act as a mobile base station, and one or more cells may move based on the location of the mobile base station. In other examples, the helicopter or drone may be configured to function as a device for communicating with another base station.

In some deployments, the network device in the embodiments of the present disclosure may refer to a CU or a DU, or the network device includes a CU and a DU. The gNB may further include an AAU.

The network device and the terminal device may be deployed on land, including indoors or outdoors, handheld or in-vehicle; they may also be deployed on water; they may also be deployed on airplanes, balloons and satellites in the air. The scenarios in which the network device and the terminal device are located are not limited in the embodiments of the present disclosure.

It should be understood that all or part of the functions of the communication device in the present disclosure may also be implemented by software functions running on hardware, or by virtualization functions instantiated on a platform (e.g., a cloud platform).

### AI

In recent years, artificial intelligence (AI) research represented by neural networks (NN) has achieved very great results in many fields, and AI will also play an important role in production and daily life for a long time in the future. In particular, as an important research direction of AI technology, machine learning (ML) has successfully solved a series of previously intractable problems by utilizing nonlinear processing capabilities of neural networks. AI technology has even demonstrated performance superior to that of humans in fields such as image recognition, speech processing, natural language processing, and games, and has therefore received more and more attention.

In AI technology, a common model is a neural network model. Neural networks are nonlinear and data-driven. Neural networks may be designed with relatively many layers. FIG. 2 is an example diagram of a neural network model. As illustrated in FIG. 2, feature learning is performed through layer-by-layer training of a multi-layer neural network, which greatly improves learning and processing capabilities of the neural networks. Therefore, the neural network model is widely used in the fields of pattern recognition, signal processing, optimization combination, anomaly detection, and the like.

Given that AI technology, especially deep learning, has achieved great success in computer vision, natural language processing and other fields, the communications field has begun to attempt to solve technical problems that are difficult to solve with traditional communication methods by using deep learning. For example, AI technology may be applied to many fields such as complex and unknown environment modeling or learning, channel prediction, intelligent signal generation and processing, network status tracking and intelligent scheduling, and network optimization deployment. AI technology is expected to promote the evolution of future communication paradigms and changes in network architecture, and is of great significance and value to 6G technology research.

The combination of AI and communications will be described below through applications of an AI model in channel state feedback and beam management in the communication field.

### AI Model-Based Channel State Information (CSI) Feedback

The terminal device may extract features from actual channel matrix data by using an AI model, and the network device may restore channel matrix information compressed and fed back by the terminal device as much as possible. Based on this, the AI model may restore channel information while also providing the possibility for the terminal device to reduce the CSI feedback overhead.

Taking the AI model as a deep learning autoencoder as an example, the AI model-based CSI feedback is introduced. Deep learning-based CSI feedback may regard channel information as a picture to be compressed, compress and feedback the channel information by using a deep learning autoencoder, and reconstruct the compressed channel picture at a transmitting terminal. Therefore, the channel information may be preserved to a greater extent.

FIG. 3 is an example diagram of a channel state information feedback system. The feedback system illustrated in FIG. 3 is implemented based on an autoencoder structure. The autoencoder is divided into parts: an encoder and a decoder. The encoder and the decoder are deployed at a transmitting terminal and a receiving terminal, respectively. After obtaining original CSI through channel estimation, the transmitting terminal compresses and encodes a channel information matrix through a neural network of the encoder, and feeds the compressed bit stream back to the receiving terminal through an air interface feedback link. The receiving terminal recovers the channel information according to the feedback bit stream through the decoder, so as to obtain the complete feedback channel information or recovered CSI (reconstructed CSI). It will be noted that a network model structure inside the encoder and the decoder illustrated in FIG. 3 may be flexibly designed.

### AI Model-Based Beam Management

In some communication protocols (e.g., the first version of an NR system, that is, R15), communications in millimeter wave frequency band were introduced, and corresponding beam management mechanisms were also introduced. In brief, beam management may be divided into uplink beam management and downlink beam management. The downlink beam management mechanism is taken as an example mainly introduced below. The downlink beam management mechanism includes downlink beam scanning, beam reporting, indication of the network device for the downlink beam, and other processes.

The downlink beam scanning process may refer to scanning transmitting beams in different directions by the network device through a downlink reference signal synchronization block (synchronization signal/PBCH block, SSB) and/or a channel state information measurement reference signal (channel state information reference signal, CSI-RS). The terminal device may perform measurement by using different receiving beams, so as to traverse all beam pair combinations. During the measurement process, the terminal device may calculate layer 1 (L1) reference signal received power (L1-RSRP) value of a beam pair. It will be noted that L1-RSRP here may also be replaced by other beam link indicators. For example, other indicators may include: L1 signal to interference plus noise ratio (L1-SINR), L1 reference signal received quality (L1-RSRQ), or the like. Here, the L1-SINR is already supported in some communication standards, and the L1-RSRQ is not supported in some communication standards.

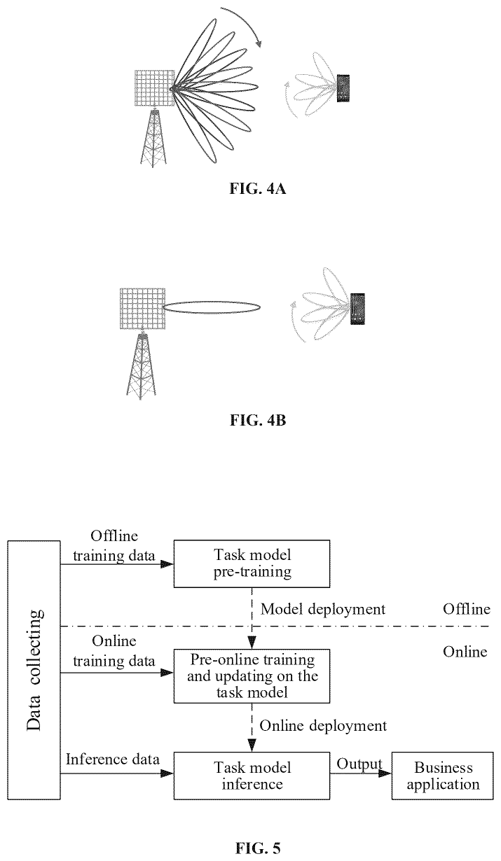

FIG. 4A and FIG. 4B are each an example diagram of a beam scanning process, in which FIG. 4A illustrates a process of traversing transmitting beams and receiving beams. FIG. 4B illustrates a process of traversing receiving beams for a particular transmitting beam.

The beam reporting may also be called optimal beam reporting. The terminal device may compare L1-RSRP values of all measured beam pairs, select K transmitting beams with the highest L1-RSRP value, and report the K transmitting beams as uplink control information to the network device. Here, K may be a positive integer. After decoding the beam reporting of the terminal device, the network device may complete beam indication to the terminal device through transmission configuration indicator (TCI) status (including a transmitting beam with the SSB or the CSI-RS as reference) carried by a medium access control control element (MAC CE) or downlink control information (DCI) signaling. The terminal device may use a receiving beam corresponding to this transmitting beam for reception.

In the discussions of some communication standards (e.g., R18), the AI-based beam management serves as one of the main use cases for an AI project of the communication standards, and has undergone multiple rounds of use case selection and simulation hypothesis discussions. Although there is no consensus on details of how to implement better beam management based on AI, AI-based spatial beam prediction and AI-based time domain prediction are considered as typical use cases. Currently, an implementation framework of AI-based beam management has reached a preliminary consensus as follows: beam prediction is implemented on beam set A (set A) through measurement results of beam set B (set B); set B may be a subset of set A, or set B and set A may be different beam sets (e.g., set A uses a narrow beam and set B uses a wide beam); the AI model may be deployed on a network device or a terminal device; and the measurement results of set B may be L1-RSRP, or other auxiliary information, such as a beam (pair) ID.

### Online Learning and Offline Learning

AI networks may create or train AI models based on training data. Models are typically trained to produce more accurate predictions. Online learning and offline learning are training methods for models in deep learning.

Offline learning may also be called offline training. During an offline learning process, all training data is available, and the training data is randomly shuffled and then used to train a model offline in batches. For offline learning methods, a model may only be used for prediction after the offline training for this model is completed.

Online learning may also be called online training. During an online learning process, the model may be updated online through online streaming data. For example, online learning methods may adjust or update the model based on one or a batch of data samples obtained in real-time. The online learning methods may capture data changes in a timely manner and effectively increase the update frequency of the model.

Currently, most simulation results are evaluated under simulated data, and evaluation under a real system is rare. Whereas, a real system environment is more complex, which poses a great challenge to model generalization. A wireless environment is not stable enough, and data distribution will inevitably be affected by factors such as time, environment, and system strategy. Therefore, the data distribution of the real system will not be strictly consistent with data distribution obtained offline. The performance of the AI model is strongly correlated with data distribution. If there is a serious difference between data from the real system and data obtained offline, the performance of the AI model pre-trained based on the offline data will be poor. As the improvement in the capabilities of the terminal device and the network device in the future, online learning solutions will be increasingly discussed with the advancement of more real system data, thus enabling the AI model to adapt to real environments. However, current discussions on the online learning solutions mainly focus on frameworks and overall processes. For example, some communication protocols (e.g., R18) have discussed the deployment of offline pre-trained models and AI frameworks for online inference.

FIG. 5 is a workflow example diagram of an online learning solution. FIG. 5 will be described below.

During an offline training phase, a device on an offline side pre-trains a task model by using collected offline training data. After pre-training is completed, the task model may be deployed.

During an online training phase, a device on an online side collects data from the real system as online training data. In a case where online training data accumulates to a certain amount, the device on the online side may perform online training once based on a deployed task model to update the task model. Training will continue until the model converges or other default termination training conditions are triggered. The updated task model may be deployed and applied online. Based on the input inference data, the deployed task model may yield corresponding inference results and output the inference results to business applications.

### AI Capability Reporting of a Terminal Device

Some companies have proposed a method to determine an AI model. The method may be performed by a terminal device. The terminal device transmits AI capability information of the terminal device. A network device may determine an AI model used by the terminal device based on the reported AI capability information. The AI capability information may include at least one of AI capability indication information, AI level indication information, identification information of the AI model, identification information of an AI platform, AI inference indication information, or AI training indication information.

In some embodiments, the AI capability information may include a reference computing capability of the terminal device (referred to as reference computing power). Generally, it is possible to determine whether a terminal device at the current has the capability to support the running of the AI model based on inference delay (also referred to as inference time) required for a given task under the reference computing power. Further, the inference delay may be determined based on the complexity of the AI model. The determined inference delay may be compared to a delay requirement of the AI model. If the inference delay meets the delay requirement, the terminal device may meet requirements of the AI model, that is, the terminal device is capable of supporting the running of the AI model. If the inference delay does not meet the delay requirement, the terminal device cannot meet the requirements, that is, the terminal device cannot support the running of the AI model.

The mathematical expression of the inference delay may meet:

$$T = \frac{C}{P} ,$$

where C may denote the computational complexity of the AI model, P may denote reference computing power of the terminal device, and T may denote the inference delay of the terminal device for the AI model. The unit of C may be floating point operations per second (FLOPS). The unit of P may be floating point operations per second (FLOPS) or tera operations per second (TOPS). Since C and P are obtained under ideal conditions, T obtained by calculating according to the formula is generally also a theoretical reference value. Taking into account constraints such as scheduling, storage, and input/output (I/O), there will be a discrepancy between actual inference delay and the theoretical reference value. Therefore, the inference delay obtained through ideal assumption conditions makes it difficult to guarantee that a model under a certain use case can keep working normally.

Capability information of a terminal device reported is based on a fixed reference indicator. Specifically, the capability information is generally reported at one time, and specific information reported thereby is an inherent attribute at the terminal device level. The inherent attribute may include, for example, an AI capability level supported by a chip of the terminal device. However, during the actual running of the terminal device, task models at different levels can work together in parallel. In other words, resources capable of being allocated to models at different times and under different tasks change dynamically. The dynamically changing resources will directly affect whether the model can operate normally and the effect of running. That is, a model determined based on the capability information of an inherent attribute category is difficult to keep working normally. That is, a model determined based on the capability information of an inherent attribute category is difficult to keep working normally. For example, the terminal device may report its inherent reference computing power as A. The network device may deploy model B for the terminal device based on A. During a running process of model B, the terminal device may further perform task C in parallel. Therefore, during the performing process of task C, task C needs to occupy part of computing power A, which will inevitably cause the running of model B to generate delay or fail to run normally.

Embodiments of the present disclosure provide a method for communication. The method includes:
transmitting, by a terminal device, first capability information;
where the first capability information is associated with a first model, and the first capability information is used for indicating one piece of following information:
information of a resource capable of being used by the first model; and
information of a running process of the first model.

In some embodiments, information of the resource capable of being used by the first model includes:
information of a resource capable of being used by the terminal device; and/or
information of a resource allocated by the terminal device to the first model.

In some embodiments, the running process of the first model includes:
an inference process of the first model; and/or
an online training process of the first model.

In some embodiments, the information of the running process includes one or more pieces of following information:
duration of the running process; or
information of resources occupied by the running process.

In some embodiments, the duration of the running process includes one or more pieces of following duration: average duration that the first model runs once, duration that the first model continuously runs one or more times, or total duration that the first model runs.

In some embodiments, the information of the resources occupied by the running process includes: a peak value of the resources occupied by the running process.

In some embodiments, the resource includes one or more of following: internal memory, video memory, computing power, or a number of threads.

In some embodiments, the method further includes:
receiving, by the terminal device, first indication information;
where the first indication information is determined based on the first capability information, and the first indication information is used for indicating one or more of following:
deploying the first model on the terminal device;
updating the first model that has been deployed to a second model on the terminal device; or
an online training strategy of the first model.

In some embodiments, the first capability information is transmitted in response to a change in the first capability information; and/or
the first capability information is transmitted periodically.

In some embodiments, the first model is an artificial intelligence (AI) model.

Embodiments of the present disclosure provide a method for communication. The method includes:
receiving, by a network device, first capability information transmitted by a terminal device;
where the first capability information is associated with a first model, and the first capability information is used for indicating one piece of following information:
information of a resource capable of being used by the first model; and
information of a running process of the first model.

In some embodiments, information of the resource capable of being used by the first model includes:
information of a resource capable of being used by the terminal device; and/or
information of a resource allocated by the terminal device to the first model.

In some embodiments, the running process of the first model includes:
an inference process of the first model; and/or
an online training process of the first model.

In some embodiments, the information of the running process includes one or more pieces of following information:
duration of the running process; or
information of resources occupied by the running process.

In some embodiments, the duration of the running process includes one or more pieces of following duration: average duration that the first model runs once, duration that the first model continuously runs one or more times, or total duration that the first model runs.

In some embodiments, the information of the resources occupied by the running process includes: a peak value of the resources occupied by the running process.

In some embodiments, the resource includes one or more of following: internal memory, video memory, computing power, or a number of threads.

In some embodiments, the method further includes:
transmitting, by the network device, first indication information to the terminal device;
where the first indication information is determined based on the first capability information, and the first indication information is used for indicating one or more of following: deploying the first model on the terminal device;
updating the first model that has been deployed to a second model on the terminal device; or
an online training strategy of the first model.

In some embodiments, the first capability information is transmitted in response to a change in the first capability information; and/or
the first capability information is transmitted periodically.

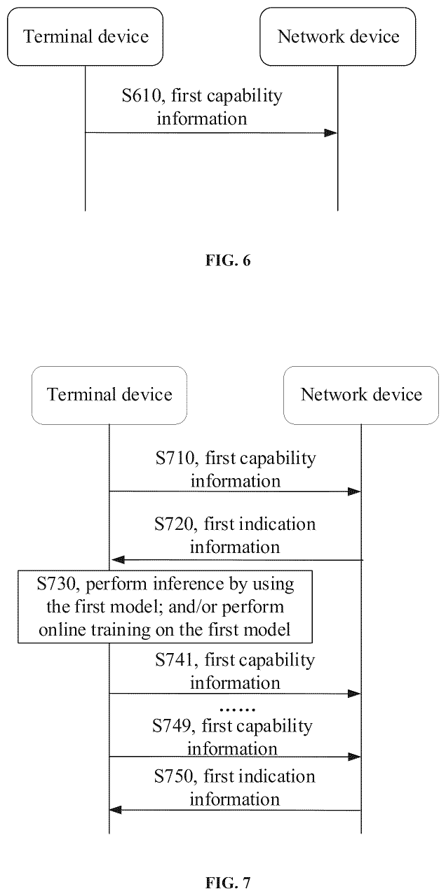

FIG. 6 is a schematic flowchart of a method provided in the embodiments of the present disclosure to solve the above problem. The method illustrated in FIG. 6 may be performed by a network device and a terminal device. The method illustrated in FIG. 6 may include step S610.

In step S610, the terminal device transmits first capability information. Correspondingly, the network device may receive the first capability information.

The first capability information may be associated with a first model. In other words, the first capability information may be used for indicating information of capability of the terminal device associated with the first model. For example, the first capability information may be used for indicating information of a resource capable of being used by the first model. Alternatively, the first capability information may be used for indicating information of a running process of the first model. The first model may be used for performing a first task, that is, the first model may be associated with the first task. In this case, the first capability information may be used for indicating information of a resource capable of being used by the first task corresponding to the first model.

During the running process of the terminal device, the resource capable of being used by the first model or running status of the first model changes dynamically. Therefore, the first capability information reported by the terminal device may change dynamically. That is, based on the first capability information, the terminal device may dynamically indicate the capability information of the terminal device. Based on the dynamic capability information, the network device may configure or adjust a suitable model or strategy for the terminal device, to enable the model to keep running normally.

In addition, in a case where the first capability information is used for indicating an actual running process of the first model, it is possible to determine whether the terminal device has the capability to support the running of the first model based on the actual running process of the first model. That is, the terminal device may report actual running status of the first model on the terminal device, so as to avoid deviations caused by theoretical calculations through ideal assumption conditions.

The resource of the terminal device may be any resource that supports the running of the first model. For example, the resource of the terminal device may include one or more of the following: internal memory, video memory, computing power, or a number of threads. The resource capable of being used by the first model may be a resource that is actually available for the first model at a current moment or in a period of time close to the current moment.

As an implementation, the information of the resource capable of being used by the first model may include information of a resource capable of being used by the terminal device (i.e., an available resource). As an implementation, the resource capable of being used by the terminal device may include one or more of the following resources: available internal memory, available video memory, available computing power, or a number of available threads.

In some embodiments, the terminal device may have a self-allocating resource capability. In other words, the terminal devices may allocate resources on its own. In this case, the terminal device may allocate a resource to the first model or a task corresponding to the first model. The resource capable of being used by the first model may include a resource (e.g., resource upper limit) allocated by the terminal device to the first model or the first task corresponding to the first model. As an implementation, the resource allocated by the terminal device to the first model or the first task may include, for example, one or more of the following: a maximum internal memory allocated to the first model, a maximum video memory allocated to the first model, an upper limit on the computing power allocated to the first model, or an upper limit on the number of threads allocated to the first model.

The first model may be deployed and run on the terminal device. The running process of the first model may include an inference process and/or a training process. The training process may be, for example, an online training process. For example, the terminal device may perform online training on the first model. Alternatively, the terminal device may implement inference or prediction based on the first model.

In some embodiments, the information of the running process may include information related to a most recent running. In this case, the information of the running process may be used for indicating the status of a current running of first model.

The information of the running process may include one or more pieces of the following information: duration of the running process, or information of resources occupied by the running process.

The running process may be a process that the first model runs one or more times. For example, during the running process, the first model may be trained online one or more times. Alternatively, during the running process, one or more inferences or predictions may be performed based on the first model. Correspondingly, the duration of the running process may be used for indicating the duration that the first model runs one or more times. For example, the duration of the running process may be used for indicating one or more pieces of the following duration: duration that the first model runs one certain time, average duration that the first model runs once, duration that the first model continuously runs multiple times, or total duration that the first model runs. Taking the running process as an inference process as an example, the duration of the running process may include average inference duration. Taking the running process as an online training process as an example, the running process may include average duration of a single step of training. Here, the duration that the first model continuously runs multiple times may include: duration that inference is performed N times continuously with the first model, and/or the duration that the first model is trained online continuously K times. Both N and K may be positive integers. Both N and K may be pre-configured, a preset value, or configured by the network device.

The information of the resources occupied by the running process may be used for indicating information related to resources occupied by the first model during the running process. The information of the resources occupied by the running process may include: one or more of the following: a peak value (a maximum value), an average value, or a valley value (a minimum value) of the resources occupied by the running process. For example, the information of the resources occupied by the running process may include one or more of the following: a peak value of internal memory or a peak value of video memory.

In some embodiments, the first capability information may further include other capabilities related to the first model. For example, the first capability information may include one or more pieces of the following information: reference indicator information of other chip capabilities of the terminal device, reference indicator information of other currently available chip capabilities, or statistical information of other processes performed by the first model.

Reporting manners of the information in the first capability information are not limited in the present disclosure. For example, the first capability information may directly report a specific value of corresponding information. Alternatively, the first capability information may indicate a range or level corresponding to a specific value of information required to be reported. Taking a case where the first capability information includes the status of video memory of the terminal device as an example, if the current video memory of the terminal device is 1G, the first capability information may directly indicate 1G, or the first capability information may indicate a level of 500M to 1.5G corresponding to 1G. The level or range of the information included in the first capability information will be described below as an example.

In some embodiments, a level to which a video memory indicator of the terminal device belongs may include one or more of: less than 500M, 500M to 1G, 1.5G to 2.5G, or greater than 2.5G. The level to which the video memory indicator belongs may be denoted by two bits. For example: {00} may denote that the video memory is less than 500M; {01} may denote that the video memory is between 500M and 1.5G; {10} may denote that the video memory is between 1.5G and 2.5G; and {11} may denote that the video memory is greater than 3G.

In some embodiments, a level to which a computing power indicator of the terminal device belongs may include one or more of: less than 5 TOPS, 5 TOPS to 10 TOPS, 10 TOPS to 30 TOPS, or greater than 30 TOPS. The level to which the computing power indicator belongs may be denoted by 2 bits. {00} may denote that the computing power is lower than 5 TOPS; {01} may denote that the computing power is between 5 TOPS and 10 TOPS; {10} may denote that the computing power is between 10 TOPS and 30 TOPS; and {11} may denote that the computing power is higher than 30 TOPS.

In some embodiments, a level to which the maximum video memory allocated to the first model by the terminal device belongs may include one or more of: less than 50M, 50M to 150M, 150M to 300M, or greater than 300M. The level to which the maximum video memory allocated to the first model belongs may be denoted by 2 bits. For example, {00} may denote that the maximum video memory allocated to the first model is less than 50M; {01} may denote that the maximum video memory allocated to the first model is between 50M and 150M; {10} may denote that the maximum video memory allocated to the first model is between 150M and 300M; and {11} may denote that the maximum video memory allocated to the first model is greater than 300M.

In some embodiments, a level to which an upper limit on the computing power allocated to the first model by the terminal device belongs may include one or more of: less than 1 TOPS, 1 TOPS to 8 TOPS, 8 TOPS to 16 TOPS, or greater than 16 TOPS. A level to which the upper limit on the computing power allocated to a first task belongs by the terminal device may be denoted by 2 bits. For example, {00} may denote that the upper limit on the computing power allocated to the first task is lower than 1 TOPS; {01} may denote that the upper limit on the computing power allocated to the first task is between 1 TOPS and 8 TOPS; {10} may denote that the upper limit on the computing power allocated to the first task is between 8 TOPS and 16 TOPS; and {11} may denote that the upper limit on the computing power allocated to the first task is higher than 16 TOPS.

In some embodiments, a level to which a peak value of the video memory during the inference process of the first model belongs may include one or more of: less than 500M, 500M to 1G, 1.5G to 2.5G, or greater than 2.5G. The level to which the peak value of the video memory during the inference process of the first model belongs may be denoted by 2 bits. For example, {00} may denote that the peak value of the video memory during the inference process of the first model is lower than 500M; {01} may denote that the peak value of the video memory during the inference process of the first model is between 500M and 1.5G; {10} may denote that the peak value of the video memory during the inference process of the first model is between 1.5G and 2.5G; and {11} may denote that the peak value of the video memory during the inference process of the first model is greater than 3G.

In some embodiments, a level to which average duration of the first model for single inference belongs may include one or more of: higher than 1e-4 s, 1e-4 s to 1e-5 s, 1e-5 s to 1e-6 s, or lower than 1e-6 s. The level to which the average duration of the first model for single inference belongs may be denoted by 2 bits. For example, {00} may denote that the average duration of the first model for single inference is higher than 1e-4 s; {01} may denote that the average duration of the first model for single inference is between 1e-4 s and 1e-5 s; {10} may denote that the average duration of the first model for single inference is between 1e-5 s and 1e-6 s; and {11} may denote that the average duration of the first model for single inference is lower than 1e-6 s.

In some embodiments, a level to which a peak value of the video memory during the online training process of the first model belongs may include one or more of: less than 500M, 500M to 1G, 1.5G to 2.5G, or greater than 2.5G. The level to which the peak value of the video memory during the online training process of the first model belongs may be denoted by 2 bits. For example, {00} may denote that the peak value of the video memory during the online training process of the first model is less than 500M; {01} may denote that the peak value of the video memory during the online training process of the first model is between 500M and 1.5G; {10} may denote that the peak value of the video memory during the online training process of the first model is between 1.5G and 2.5G; and {11} may denote that the peak value of the video memory during the online training process of the first model is greater than 3G.

In some embodiments, a level to which average duration of single step training of the first model belongs may include one or more of: higher than 1e-4 s, 1e-4 s to 1e-5 s, 1e-5 s to 1e-6 s, or lower than 1e-6 s. The level to which the average duration of the single step training of the first model belongs may be denoted by 2 bits. For example, {00} may denote that the average duration of the single step training of the first model is higher than 1e-4 s; {01} may denote that the average duration of the single step training of the first model is between 1e-4 s and 1e-5 s; {10} may denote that the average duration of the single step training of the first model is between 1e-5 s and 1e-6 s; and {11} may denote that the average duration of the single step training of the first model is lower than 1e-6 s.

In some embodiments, the first capability information may further include a type of the first capability information. The type may be denoted by 2 bits. For example, {00} may denote type 1, that is, a case where the terminal device has a self-allocating resource capability; {01} may denote type 2, that is, a case where the terminal device does not have the self-allocating resource capability; {10} may denote type 3, that is, the first capability information is used for feeding back inference running status; and {11} may denote type 4, that is, the first capability information is used for feeding back online training running status. It can be understood that the first capability information of type 4 may be activated and reported only in a case where there is an online training task.

As an implementation, the first capability information may be denoted by 6 bits. First 2 bits of the 6 bits may be used for indicating the type of the first capability information. Last 4 bits of the 6 bits may be used for indicating specific contents. For example, in a case where the first capability information is of type 1, the last 4 bits may be used for indicating the level to which the video memory indicator of the terminal device belongs and the level to which the computing power indicator of the terminal device belongs. In a case where the first capability information is of type 2, the last 4 bits may be used for indicating the level to which the maximum video memory allocated to the first model by the terminal device belongs and the level to which the upper limit on the computing power level allocated to the first model by the terminal device belongs. In a case where the first capability information is of type 3, the last 4 bits may be used for indicating the level to which the peak value of the video memory during the inference process of the first model belongs and the level to which the average duration of for single inference belongs. In a case where the first capability information is of type 4, the last 4 bits may be used for indicating the level to which the peak value of the video memory during the online training process of the first model belongs and the level to which the average duration of the single step training belongs.

It will be noted that tasks performed by the first model are not limited in the present disclosure. For example, the first model may be used for CSI feedback or beam prediction. Taking an example that the first model may be used for CSI feedback, in a case where the terminal device performs a CSI prediction task through the first model, the first model may include an encoder; and in a case where the terminal device performs online training on a model corresponding to a CSI feedback task, the first model may include an encoder and a decoder. During a prediction process, the encoder and the decoder are deployed on a terminal device side and a network device side, respectively, and the encoder and the decoder are required to be jointed during the online training process. Therefore, the first model deployed on the device side may include a same decoder as that on the network device side. During an online training process, only parameters of the encoder may be updated. Taking the first model used for beam management as an example, the first model may be a beam prediction model.

It will be noted that the first model may be an AI model. For example, the first model may be a neural network model or a machine learning model. In a case where the first model is the AI model, the first capability information may be used for indicating information of AI-related capabilities of the terminal device.

It will be noted that a type of a message carrying the first capability information is not limited in the present disclosure. The first capability information may be carried in UCI or other uplink signaling.

The reporting of the first capability information may be periodic or event-triggered. For example, in a case where the first capability information changes, the reporting of the first capability information may be triggered. A period for reporting the first capability information may meet one of the following: being a preset value, being configured by a network, or being a preset value. The period for reporting the first capability information is not limited in the present disclosure, for example, the period may be 30 ms, 50 ms or 70 ms.

In some embodiments, the first capability information may be reported in a case where the first model has not yet been deployed on the terminal device. For example, in response to the terminal device accessing the network, the terminal device may report the first capability information. In some embodiments, the first capability information may be reported in a case where the first model has been deployed on the terminal device.

The first capability information may provide dynamic change information of resources of the terminal device and/or actual running status of the first model. Based on the received first capability information, The network device may determine scale and parameters of a model, or a strategy of training the model for the terminal device. Based on the first capability information, the network device may further reasonably select a model and/or an online training strategy. For example, the network device may determine inference delay based on inference duration indicated by the first capability information, so as to select a model with the largest scale and/or the optimal online training strategy that meets the inference delay requirement. Models with larger scale tend to have higher performance (e.g., accuracy), and the optimal training strategy may achieve higher online update efficiency.

It may be seen that based on the first capability information, the network device may configure a more suitable model and/or online training strategy for the terminal device, so as to maximize the capabilities of the terminal device as much as possible, thereby improving the running performance of the first model while avoiding problems such as running failure, inference timeout, failure of online training to converge within a specified time, etc., of the first model.

In a case where the network device determines a model and/or an online training strategy, the network device may transmit first indication information to the terminal device.

In some embodiments, the first indication information may be used for deploying and updating a model on the terminal device. For example, in a case where the first model has not yet been deployed on the terminal device, the first indication information may be used for indicating deploying the first model on the terminal device; and in a case where the first model has been deployed on the terminal device, the first indication information may be used for indicating updating the first model to the second model.

In a case where the terminal device performs online training on the first model, the first indication information may be used for indicating an online training strategy of the first model. The online training strategy may be used for indicating the terminal device how to perform the online training on the first model. The online training strategy may include, for example, one or more pieces of the following information: frequency of the online training, a number of samples used in the online training, a starting parameter of the online training, whether the online training is periodic, or whether the online training is performed sample by sample.

The method provided by the present disclosure is described in detail below in conjunction with FIG. 7. The method illustrated in FIG. 7 may include steps S710 to S750.

In step S710, a terminal device transmits first capability information to a network device.

Step S710 may occur in an initial access phase. In the initial access phase, a model corresponding to a first task has not been configured on the terminal device.

In step S710, the first capability information may be used for indicating information of a resource capable of being used by a first model or the first task.

In a case where the terminal device does not have a self-allocating resource capability, the information of the resource capable of being used by the first model may include: a level to which a current video memory indicator of the terminal device belongs, and/or a level to which a current computing power indicator of the terminal device belongs. In this case, a type of the first capability information may be marked as type 1.

In a case where the terminal device has the self-allocating resource capability, the information of the resource capable of being used by the first model may include: a level to which a maximum video memory allocated by the terminal device to the first task belongs, and/or a level to which an upper limit on computing power allocated by the terminal device to the first task belongs. In this case, the type of the first capability information may be marked as type 2.

Based on the contents and/or type of the first capability information, the network device may determine scale of the first model or the online training strategy of the first model.

In step S720, the network device transmits first indication information to the terminal device.

In step S720, the first indication information may be used for indicating deploying the first model on the terminal device; and/or the first indication information may be used for indicating an online training strategy of the first model.

In step S730, the terminal device may complete the deployment of the first model and perform one or more of the following operations: performing inference by using the first model or performing online training on the first model.

In some embodiments, the terminal device may start online training by using real data collected from a real system.

After completing the deployment of the first model, the terminal device may report the first capability information one or more times. That is, the terminal device may perform steps S741 to S749. It will be noted that steps S741 to S749 in FIG. 7 are merely examples, and a number of times that the first capability information is reported is not limited in the present disclosure.

In steps S741 to S749, the type of the first capability information may be type 1 or type 2 as described above. Alternatively, the first capability information may be used for indicating information of a running process of the first model, that is, the type of the first capability information may be type 3 or type 4 described below.

In a case where the running process is an inference process, the first capability information may include: a level to which a peak value of video memory during the inference process belongs, and/or average inference duration. In this case, the type of the first capability information may be type 3.

In a case where the running process is an online training process, the first capability information may include: a level to which a peak value of video memory of the online training process belongs, and/or average duration for a single step of the online training. In this case, the type of the first capability information may be type 4.

Based on part or all of the first capability information reported in steps S741 to S749, the network device may perform one or more of the following operations: determining whether to update the first model, determining scale of an updated second model, or adjusting the online training strategy of the first model.

In step S750, the network device transmits first indication information to the terminal device.

In step S750, the first indication information may include one or more pieces of the following information: updating the first model that has been deployed on the terminal device to the second model, or the online training strategy of the first model.

Here, steps 710 to S720 may belong to a first phase, and steps S730 to S750 may belong to a second phase. It can be understood that in both the first phase and the second phase, the terminal device may transmit the first capability information. The first capability information may have different types and different contents in different phases. For example, in the first phase, the terminal device may report the first capability information of type 1 and/or type 2; and in the second phase, the terminal device may report first capability information of any one or more types among type 1, type 2, type 3, or type 4. The first capability information of type 3 or type 4 may be reported simultaneously or successively with the first capability information of type 1 or type 2.

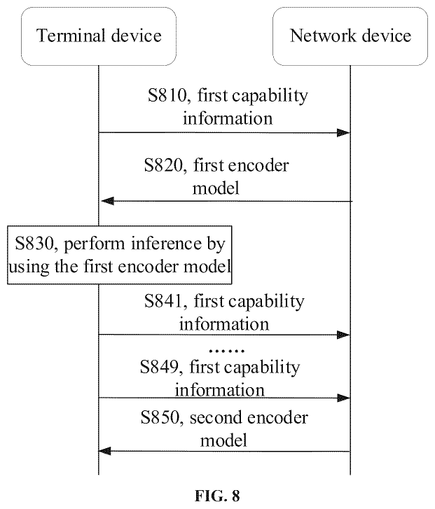

The present disclosure is briefly introduced below through FIGS. 8 to 10 in combination with the first model being a CSI feedback model or a beam prediction mode.

FIG. 8 takes an example that the first model is a first encoder model used for CSI feedback. The method illustrated in FIG. 8 may include steps S810 to S850.

In step S810, a terminal device transmits first capability information to a network device.

Based on the first capability information, the network device determines a first encoder model.

In step S820, the network device deploys the first encoder model for the terminal device.

In step S830, the terminal device performs inference using the first encoder model.

In steps S841 to S849, the terminal device transmits the first capability information to the network device one or more times.

Based on the first capability information in steps S841 to S849, the network device determines to update the first encoder model on the terminal device to a second encoder model.

In step S850, the network device updates the first encoder model deployed by the terminal device to the second encoder model.

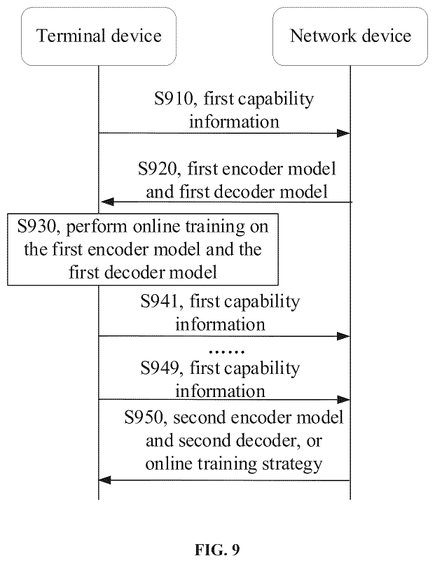

FIG. 9 takes an example that the first model includes a first encoder model and a first decoder model that are used for CSI feedback. The method illustrated in FIG. 9 may include steps $910 to S950.

In step S910, a terminal device transmits first capability information to a network device.

Based on the first capability information, the network device determines a first encoder model and a first decoder model.

In step S920, the network device deploys the first encoder model and the first decoder model for the terminal device.

In step S930, the terminal device performs online training on the first encoder model and the first decoder model.

In steps S941 to S949, the terminal device transmits the first capability information to the network device one or more times.

Based on the first capability information in steps S941 to S949, the network device determines to update the first encoder model and the first decoder model on the terminal device to a second encoder model and a second decoder model; alternatively, the network device determines an online training strategy of the first encoder model and the first decoder model.

In step S950, the network device updates the first encoder model and the first decoder model that are deployed by the terminal device to a second encoder model and a second decoder model; alternatively, the network device transmits an online training strategy to the terminal device.

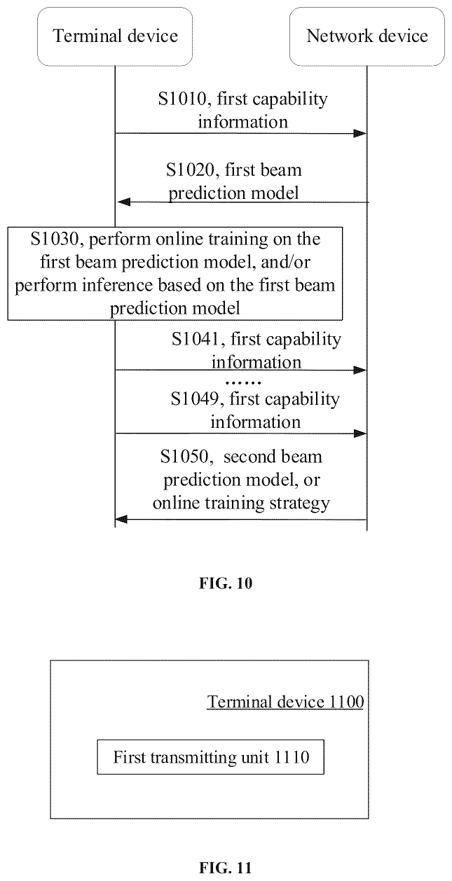

FIG. 10 takes an example that the first model is a first beam prediction model. The method illustrated in FIG. 10 may include steps S1010 to S1050.

In step S1010, a terminal device transmits first capability information to a network device.

Based on the first capability information, the network device determines a first beam prediction model.

In step S1020, the network device deploys the first beam prediction model for the terminal device.

In step S1030, the terminal device performs online training on the first beam prediction model; and/or the terminal device performs inference based on the first beam prediction model.

In steps S1041 to S1049, the terminal device transmits the first capability information to the network device one or more times.

Based on the first capability information in steps S1041 to S1049, the network device determines to update the first beam prediction model on the terminal device to a second beam prediction model; alternatively, the network device determines an online training strategy of the first beam prediction model.

In step S1050, the network device updates the first beam prediction model deployed by the terminal device to the second beam prediction model; alternatively, the network device transmits the online training strategy to the terminal device.

The method embodiments of the present disclosure are described in detail above, and the device/apparatus embodiments will be described in detail below in conjunction with FIGS. 11 to 13. It should be understood that the description of the method embodiments corresponds to the description of the device/apparatus embodiments, and therefore, for parts that are not described in detail may refer to that of the method embodiments.

FIG. 11 is a schematic structural diagram of a terminal device 1100 provided in the embodiments of the present disclosure. The terminal device 1100 may include a first transmitting unit 1110.

The first transmitting unit 1110 is configured to transmit first capability information; where the first capability information is associated with a first model, and the first capability information is used for indicating one piece of the following information:
information of a resource capable of being used by the first model; and
information of a running process of the first model.

In some embodiments, the resource capable of being used by the first model includes: information of a resource capable of being used by the terminal device, and/or information of a resource allocated by the terminal device to the first model.

In some embodiments, the running process of the first model includes: an inference process of the first model, and/or an online training process of the first model.

In some embodiments, the information of the running process includes one or more pieces of the following information: duration of the running process, or information of resources occupied by the running process.

In some embodiments, the duration of the running process includes one or more pieces of the following duration: average duration that the first model runs once, duration that the first model continuously runs one or more times, or total duration that the first model runs.

In some embodiments, the information of the resources occupied by the running process includes: a peak value of the resources occupied by the running process.

In some embodiments, the resource includes one or more of the following: internal memory, video memory, computing power, or a number of threads.

In some embodiments, the terminal device further includes: a first receiving unit, configured to receive first indication information; where the first indication information is determined based on the first capability information, and the first indication information is used for indicating one or more of the following: deploying the first model on the terminal device, updating the first model that has been deployed to a second model on the terminal device, or an online training strategy of the first model.

In some embodiments, the first capability information is transmitted in response to a change in the first capability information; and/or the first capability information is transmitted periodically.

In some embodiments, the first model is an AI model.

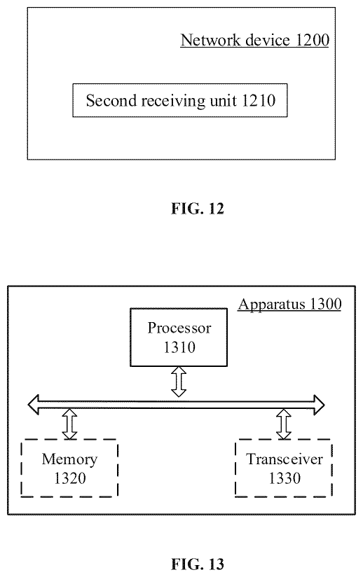

FIG. 12 is a schematic structural diagram of a network device 1200 provided in the embodiments of the present disclosure. The network device 1200 may include a second receiving unit 1210.

The second receiving unit 1210 is configured to receive first capability information transmitted by a terminal device; where the first capability information is associated with a first model, and the first capability information is used for indicating one piece of the following information: information of a resource capable of being used by the first model, and information of a running process of the first model.

In some embodiments, the resource capable of being used by the first model includes: information of a resource capable of being used by the terminal device, and/or information of a resource allocated by the terminal device to the first model.

In some embodiments, the running process of the first model includes:
an inference process of the first model; and/or
an online training process of the first model.

In some embodiments, the information of the running process includes one or more pieces of the following information: duration of the running process, or information of resources occupied by the running process.

In some embodiments, the duration of the running process includes one or more pieces of the following duration: average duration that the first model runs once, duration that the first model continuously runs one or more times, or total duration that the first model runs.

In some embodiments, the information of the resources occupied by the running process includes: a peak value of the resources occupied by the running process.

In some embodiments, the resource includes one or more of the following: internal memory, video memory, computing power, or a number of threads.

In some embodiments, the network device further includes: a second transmitting unit, configured to transmit first indication information to the terminal device; where the first indication information is determined based on the first capability information, and the first indication information is used for indicating one or more of the following: deploying the first model on the terminal device, updating the first model that has been deployed to a second model on the terminal device, or an online training strategy of the first model.

In some embodiments, the first capability information is transmitted in response to a change in the first capability information; and/or the first capability information is transmitted periodically.

In some embodiments, the first model is an AI model.

In an optional embodiment, the first transmitting unit 1110 or the second receiving unit 1210 may be a transceiver 1330. The terminal device 1100 or the network device 1200 may further include a memory 1320 and a processor 1310, as specifically illustrated in FIG. 13.

FIG. 13 is a schematic structural diagram of an apparatus for communication provided in the embodiments of the present disclosure. A unit or module with the dashed line in FIG. 13 is indicated as optional. The apparatus 1300 may be configured to implement the methods described in the above method embodiments. The apparatus 1300 may be a chip, a terminal device or a network device.

The apparatus 1300 may include one or more processors 1310. The processor 1310 may support the apparatus 1300 to implement the methods described in the above method embodiments. The processor 1310 may be a general purpose processor or a special purpose processor. For example, the processor may be a central processing unit (CPU). Alternatively, the processor may be another general purpose processor, a digital signal processor (DSP), an application specific integrated circuit (ASIC), a field programmable gate array (FPGA) or another programmable logic device, a discrete gate or a transistor logic device, a discrete hardware component, or the like. The general purpose processor may be a microprocessor, or the processor may be any conventional processor or the like.

The apparatus 1300 may further include one or more memories 1320. The memory 1320 has stored thereon a program, and the program may be executed by the processor 1310, to enable the processor 1310 to perform the methods described in the above method embodiments. The memory 1320 may be independent of the processor 1310 or may be integrated into the processor 1310.

The apparatus 1300 may further include a transceiver 1330. The processor 1310 may communicate with other devices or chips through the transceiver 1330. For example, the processor 1310 may transmit and receive data with other devices or chips through the transceiver 1330.

The embodiments of the present disclosure further provide a non-transitory computer-readable storage medium for storing a program. The non-transitory computer-readable storage medium may be applied to the terminal device or the network device provided in the embodiments of the present disclosure, and the program enables a computer to perform the methods performed by the terminal device or the network device in various embodiments of the present disclosure.

The embodiments of the present disclosure further provide a computer program product. The computer program product includes a program. The computer program product may be applied to the terminal device or the network device provided in the embodiments of the present disclosure, and the program enables a computer to perform the methods performed by the terminal device or the network device in various embodiments of the present disclosure.

The embodiments of the present disclosure further provide a computer program. The computer program may be applied to the terminal device or the network device provided in the embodiments of the present disclosure, and the computer program enables a computer to perform the methods performed by the terminal device or the network device in various embodiments of the present disclosure.

It should be understood that the terms “system” and “network” may be used interchangeably in the present disclosure. In addition, the terms used in the present disclosure are only used for explanation of embodiments of the present disclosure and are not intended to limit the present disclosure. The terms “first,” “second,” “third,” “fourth,” and the like in the specification, claims and drawings of the present disclosure are used to distinguish different objects and are not used to describe a specified sequence. Furthermore, the terms “include,” “have” and any variations thereof, are intended to cover a non-exclusive inclusion.

The “indicate” mentioned in the embodiments of the present disclosure may mean a direct indication or an indirect indication, or represent that there is an associated relationship. For example, A indicates B, which may mean that A directly indicates B, for example, B may be obtained through A; or it may mean that A indirectly indicates B, for example, A indicates C, and B may be obtained through C; or it may mean that there is an association relationship between A and B.

In the embodiments of the present disclosure, “B corresponding to A” means that B is associated with A, and B may be determined according to A. However, it should also be understood that determining B according to A does not mean determining B only according to A, B may also be determined according to A and/or other information.

In the embodiments of the present disclosure, the term “correspond” may mean that there is a direct correspondence or an indirect correspondence between the two, or it may mean that there is an association relationship between the two, or it may mean a relationship of indicating and being indicated, configuring and being configured, or the like.

In the embodiments of the present disclosure, “pre-defined” or “pre-configured” may be achieved by pre-saving corresponding codes, forms or other manners used for indicating related information in devices (e.g., including a terminal device and a network device), and the present disclosure is not limited to implementation thereof. For example, being pre-defined may refer to what is defined in a protocol.

In the embodiments of the present disclosure, the “protocol” may refer to a standard protocol in the field of communications, for example, the “protocol” may include an LTE protocol, an NR protocol, or related protocols applied in future communication systems, which will not be limited in the present disclosure.

In the embodiments of the present disclosure, the term “and/or” is only a description of an association relationship of associated objects, and indicates that there may be three kinds of relationships. For example, “A and/or B” may represent three cases: A exists alone, both A and B exist, and B exists alone. In addition, the character “/” herein generally indicates that the associated objects before and after this character are in an “or” relationship.

In various embodiments of the present disclosure, the magnitude of the serial numbers of the above processes does not mean an execution order. The execution order of each process should be determined by its function and internal logic, and should not constitute any limitation on the implementation process of the embodiments of the present disclosure.

In several embodiments provided by the present disclosure, it should be understood that the disclosed system, apparatuses and methods may be implemented in other manners. For example, the device/apparatus embodiments described above are only schematic. For example, the division of the units is only division of logical functions, and there may be other division manners in the actual implementation, such as a plurality of units or components may be combined or integrated into another system, or some features may be ignored or not implemented. In addition, the mutual coupling or direct coupling or communication connection illustrated or discussed may be indirect coupling or communication connection through some interfaces, devices/apparatuses, or units, which may be in electrical, mechanical or other forms.

The units described as separation components may or may not be physically separated, and the components shown as units may or may not be physical units, that is, they may be located at one place, or may be distributed onto a plurality of network units. Some or all of the units may be selected according to actual requirements to implement the purpose of the solution of the embodiments.

In addition, various functional units in various embodiments of the present disclosure may be integrated into one processing unit, or various units may exist physically alone, or two or more units may be integrated into one unit.

All or part of the above embodiments may be implemented by software, hardware, firmware or any combination thereof. When implemented using software, all or part of the above embodiments may be implemented in a form of the computer program product. The computer program product includes one or more computer instructions. When the computer program instructions are loaded and executed on a computer, the process or the function described in the embodiments of the present disclosure is generated in all or part. The computer may be a general purpose computer, a special purpose computer, a computer network, or another programmable apparatus. The computer instructions may be stored in a non-transitory computer-readable storage medium, or transmitted from one non-transitory computer-readable storage medium to another non-transitory computer-readable storage medium. For example, the computer instructions may be transmitted from a website, computer, server, or data center to another website, computer, server, or data center through wired manner (e.g., coaxial cable, optical fiber, or digital subscriber line (DSL)) or wireless manner (e.g., infrared, radio, or microwave). The non-transitory computer-readable storage medium may be any available medium that is capable of being read by the computer or a data storage device (e.g., a server or a data center) that includes one or more available media. The available medium may be a magnetic medium (e.g., a floppy disk, a hard disk, or a magnetic tape), an optical medium (e.g., a digital video disc (DVD)), or a semiconductor medium (e.g., a solid state disk (SSD)).

The foregoing descriptions are merely implementations of the present disclosure, but the protection scope of the present disclosure is not limited thereto. Any skilled person in the art could readily conceive of changes or replacements within the technical scope of the present disclosure, which shall be all included in the protection scope of the present disclosure. Therefore, the protection scope of the present disclosure shall be subject to the protection scope of claims.

What is claimed is:

1. A method for communication, comprising:
transmitting, by a terminal device, first capability information;
wherein the first capability information is associated with a first model, and the first capability information is used for indicating one piece of following information:
information of a resource capable of being used by the first model; and
information of a running process of the first model.

2. The method according to claim 1, wherein information of the resource capable of being used by the first model comprises:
information of a resource capable of being used by the terminal device; and/or
information of a resource allocated by the terminal device to the first model.

3. The method according to claim 1, wherein the running process of the first model comprises:
an inference process of the first model; and/or
an online training process of the first model.

4. The method according to claim 1, wherein the information of the running process comprises one or more pieces of following information:
duration of the running process; or
information of resources occupied by the running process;
wherein the duration of the running process comprises one or more pieces of following duration: average duration that the first model runs once, duration that the first model continuously runs one or more times, or total duration that the first model runs.

5. The method according to claim 4 wherein the information of the resources occupied by the running process comprises: a peak value of the resources occupied by the running process.

6. The method according to claim 1, wherein the resource comprises one or more of following:
internal memory, video memory, computing power, or a number of threads.

7. The method according to claim 1, further comprising:
receiving, by the terminal device, first indication information;
wherein the first indication information is determined based on the first capability information, and the first indication information is used for indicating one or more of following:
deploying the first model on the terminal device;
updating the first model that has been deployed to a second model on the terminal device; or
an online training strategy of the first model.

8. The method according to claim 1, wherein
the first capability information is transmitted in response to a change in the first capability information; and/or
the first capability information is transmitted periodically; and/or
the first model is an artificial intelligence (AI) model.

9. A network device, comprising a memory and a processor, wherein the memory is configured to store a program, and the program in the memory which, when executed by the processor, enables the network device to perform:
receiving first capability information transmitted by a terminal device;
wherein the first capability information is associated with a first model, and the first capability information is used for indicating one piece of following information:
information of a resource capable of being used by the first model; and
information of a running process of the first model.

10. The network device according to claim 9, wherein information of the resource capable of being used by the first model comprises:
information of a resource capable of being used by the terminal device; and/or
information of a resource allocated by the terminal device to the first model;
and/or
the running process of the first model comprises:
an inference process of the first model; and/or
an online training process of the first model.

11. The network device according to claim 9, wherein the information of the running process comprises one or more pieces of following information:
duration of the running process; or
information of resources occupied by the running process;
wherein the duration of the running process comprises one or more pieces of following duration: average duration that the first model runs once, duration that the first model continuously runs one or more times, or total duration that the first model runs.

12. The network device according to claim 11, wherein the information of the resources occupied by the running process comprises: a peak value of the resources occupied by the running process; and/or
the resource comprises one or more of following: internal memory, video memory, computing power, or a number of threads.

13. The network device according to claim 9, wherein the program in the memory which, when executed by the processor, enables the network device further to perform:
transmitting first indication information to the terminal device;
wherein the first indication information is determined based on the first capability information, and the first indication information is used for indicating one or more of following:
deploying the first model on the terminal device;
updating the first model that has been deployed to a second model on the terminal device; or
an online training strategy of the first model.

14. The network device according to claim 9, wherein
the first capability information is transmitted in response to a change in the first capability information; and/or
the first capability information is transmitted periodically; and/or
the first model is an artificial intelligence (AI) model.

15. A terminal device, comprising a memory and a processor, wherein the memory is configured to store a program, and the program in the memory which, when executed by the processor, enables the terminal device to perform:
transmitting first capability information;
wherein the first capability information is associated with a first model, and the first capability information is used for indicating one piece of following information:
information of a resource capable of being used by the first model; and
information of a running process of the first model.

16. The terminal device according to claim 15, wherein the information of a resource capable of being used by the first model comprises:
information of a resource capable of being used by the terminal device; and/or
information of a resource allocated by the terminal device to the first model;
and/or
the running process of the first model comprises:
an inference process of the first model; and/or
an online training process of the first model.

17. The terminal device according to claim 15, wherein the information of the running process comprises one or more pieces of following information:
duration of the running process; or
information of resources occupied by the running process;
wherein the duration of the running process comprises one or more pieces of following duration: average duration that the first model runs once, duration that the first model continuously runs one or more times, or total duration that the first model runs.

18. The terminal device according to claim 17, wherein the information of the resources occupied by the running process comprises: a peak value of the resources occupied by the running process; and/or
the resource comprises one or more of following: internal memory, video memory, computing power, or a number of threads.

19. The terminal device according to claim 15, wherein the program in the memory which, when executed by the processor, enables the terminal device further to perform:
receiving first indication information;
wherein the first indication information is determined based on the first capability information, and the first indication information is used for indicating one or more of following:
deploying the first model on the terminal device;
updating the first model that has been deployed to a second model on the terminal device; or
an online training strategy of the first model.

20. The terminal device according to claim 15, wherein
the first capability information is transmitted in response to a change in the first capability information; and/or
the first capability information is transmitted periodically; and/or
the first model is an artificial intelligence (AI) model.
